(19) United States
(12) Patent Application Publication
(10) Pub. No.: US 2004/0157121 A1
(43) Pub. Date: Aug. 12, 2004

(54) Electrochemical cell

(76) Inventors: Shunji Watanabe, Miyagi (JP); Yoshibumi Nakamura, Miyagi (JP); Hideharu Onodera, Miyagi (JP); Tsugio Sakai, Miyagi (JP)

Correspondence Address: ADAMS & WILKS, 31st Floor, 50 Broadway, New York, NY, 10004, US

(21) Appl. No.: 10/756,678

(22) Filed: Jan. 13, 2004

(30) Foreign Application Priority Data
Jan. 23, 2003 (JP) 2003-015364

(51) Int. Cl. H01M 2/08; H01M 2/16; H01M 4/66; H01M 4/64

(52) U.S. Cl. 429/185; 429/254; 429/247; 429/233; 429/245

(57) ABSTRACT

For avoiding problems in existent non-aqueous electrolyte cells or electric double layer capacitors of a rectangular pyramidal shape that sealing at high reliability can not be attained unless a bonded portion has a margin of a certain degree in view of electrolytes contained therein, a metal layer comprising a metal ring and a brazing material having a heat expansion coefficient approximate to that of a concave vessel of a non-aqueous electrolyte cell or an electric doceble layer capacitor is disposed to the edge of the vessel, a sealing plate made of a metal having a property similar with the metal ring and having a brazing material layer at the bonded surface is also used for the sealing plate and, further, paired electrodes comprising a positive electrode and a negative electrode, a separator and an electrolyte are contained in the concave vessel, the sealing plate is placed on the vessel and seam welding is conducted by using a resistance welding method thereby capable of attaining sealing at high reliability.

### BACKGROUND OF THE INVENTION

1. Field of the Invention

The present invention concerns an electrochemical cell capable of being surface-mounted such as a non-aqueous electrolyte cell and an electric double layer capacitor utilizing the principle of the electric double layer.

2. Statement of the Prior Art

Electrochemical cells such as non-aqueous electrolyte cells and electric double layer capacitors have been used so far as back-up power sources for clock function, back-up power sources for semiconductor memories, spare power sources for electronic devices such as microcomputers or IC memories, cells for solar clocks and motor driving power sources and, in recent years, they have also been studied, for example, as power sources for electric motor cars and auxiliary power storage units for energy conversion storage systems.

In electrochemical cells such as non-aqueous electrolyte cells and electric double layer capacitors, requirement for large capacity and current has been decreased by the development of non-volatile semiconductor memories and lowering of consumption power in clock-function devices. Requirement has been increased for non-aqueous electrolyte cells and electric double layer capacitors has rather for reduction of thickness or reflow soldering (method of previously coating a soldering cream to a portion on a printed substrate to be applied with soldering and mounting parts to the portion, or supplying small soldering balls (soldering bumps) to a portion to be soldered after mounting parts and passing a printed substrate mounting the parts thereon in a furnace of a high temperature atmosphere set to a temperature higher than the melting point of the solder, for example, at 200 to 260° C. for the portion to be soldered, thereby melting the solder to conduct soldering).

FIG. 2 shows an existent electrochemical cell. A positive electrode comprising a positive electrode active substance 201 and an electrode collector 202, and a negative electrode comprising a negative electrode active substance 204 and an electrode collector 202 are separated by a separator 208 and retained together with an electrolyte 206 by a positive electrode case 203 and a negative electrode case 205. The positive electrode case 203 and the negative electrode case 205 are caulked and sealed by way of a gasket 207. In the existent electrochemical cell, since the cross section has a circular shape such as coin or a button it is necessary that terminals, etc. have to be welded previously to the casing for conducting reflow soldering, which increased the cost in view of increase in the number of parts and increase in the number of manufacturing steps. Further, a space for the terminal has to be provided on a substrate to impose a limit on the size reduction.

While an electrochemical cell of a square shape has also been studied, it has become difficult to take a sealing space along with reduction of the size.

[Patent Document 1]

JP-A No. 2001-216952

An electrochemical cell of a square shape can not be sealed by crimping the case different from round shape cell. Therefore, it has been obliged for sealing to bond a sealing plate by some or other means to an upper portion of a concave vessel. The bonding method included a method of using adhesives, hot press bonding, laser welding, supersonic welding, and resistance welding.

However, since the non-aqueous electrolyte cell or electric double layer capacitor contains an electrolyte in the inside, it was impossible to attain sealing at a high reliability unless a margin is provided for the bonded portion to some extent.

For example, in a case of placing a brazing material such as a brazing material or a soldering material of a shape substantially identical with the edge of a concave vessel to the edge thereof, sandwiching the same by using a sealing plate, heating the sealing plate at a temperature higher than the melting point of the brazing material or the soldering material and pressing them to apply sealing, no sufficient sealing could be attained since the electrolyte present inside was heated and would leach to the outside unless there is no margin for the bonded portion to some extent.

### SUMMARY OF THE INVENTION

For solving the subject described above, a metal layer is disposed to the edge of a concave vessel for an electrochemical cell and bonding the concave vessel and the sealing plate by the metal layer to improve the sealability. Paired electrodes comprising a positive electrode and a negative electrode, a separator and an electrolyte are contained in the concave vessel, a sealing plate is placed thereon and seam welding is applied by using a resistance welding method, thereby enabling to attain sealing at high reliability.

Then, the metal layer comprises a metal ring and a brazing material having a heat expansion coefficient approximate to that of the concave vessel, and the concave vessel and the sealing plate are bonded by the resistance welding method. The concave vessel is preferably made of ceramics or ceramic glass. Further, it is preferred that the metal ring comprises an alloy containing cobalt, nickel and iron, and the brazing material is preferably a nickel and/or gold film formed on the metal ring.

The sealing plate comprises a metal in which a brazing material is formed at the surface on the side bonded with the concave vessel. More preferably, the metal of the sealing plate comprises an alloy containing cobalt, nickel and iron, and the brazing material formed at the surface on the side bonded with the concave vessel is a nickel and/or gold film. The brazing material is formed by plating or printing. It is preferred that the thickness of the metal layer situated to the edge of the concave vessel is less than the total thickness for the electrode situated on the side of the sealing plate and the separator.

A step is formed inside the vessel and the separator is located on the step.

An electrode collector is disposed at the bottom inside the concave vessel. The electrode collector preferably comprises a material mainly composed of elements selected from tungsten, aluminum, carbon, palladium, silver, platinum and gold. More preferably, a conductive layer mainly composed of carbon is disposed on the electrode collector.

Further, the separator is made of non-woven fabrics comprising, as the main ingredient, polyphenylene sulfide, polyetheretherketone or glass fibers.

### DESCRIPTION OF THE ACCOMPANYING DRAWINGS

Preferred embodiments of the present invention will be described in details based on the drawings, wherein

FIG. 1 is a cross sectional view of an aqueous electrolyte cell or electric double layer capacitor according to the present invention;

FIG. 2 is a cross sectional view of an existent non-aqueous electrolyte cell or electric double layer capacitor;

FIG. 3 is a cross sectional view in a case where the thickness of a metal layer is more than the total thickness for a negative electrode active substance 107 and a separator 105;

FIG. 4 is a cross sectional view of a non-aqueous electrolyte cell or electric double layer capacitor in a case of providing a step inside a concave vessel 101 of the invention; and

FIG. 5 is a cross sectional view of a non-aqueous electrolyte cell or electric double layer capacitor in a case of providing a step inside a concave vessel 101 of the invention.

### PREFERRED EMBODIMENTS OF THE INVENTION

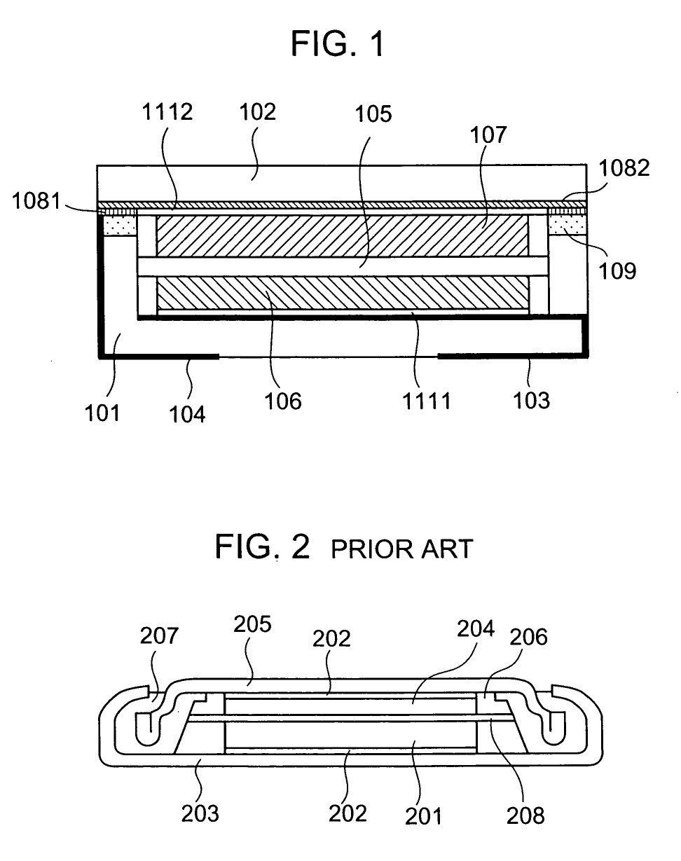

The present invention is to be described for a typical structure with reference to FIG. 1. In the non-aqueous electrolyte cell or electric double layer capacitor of the invention, it is effective to make the shape, mainly, as a rectangular pyramidal form for reducing the ratio of mounting are to the space in surface mounting.

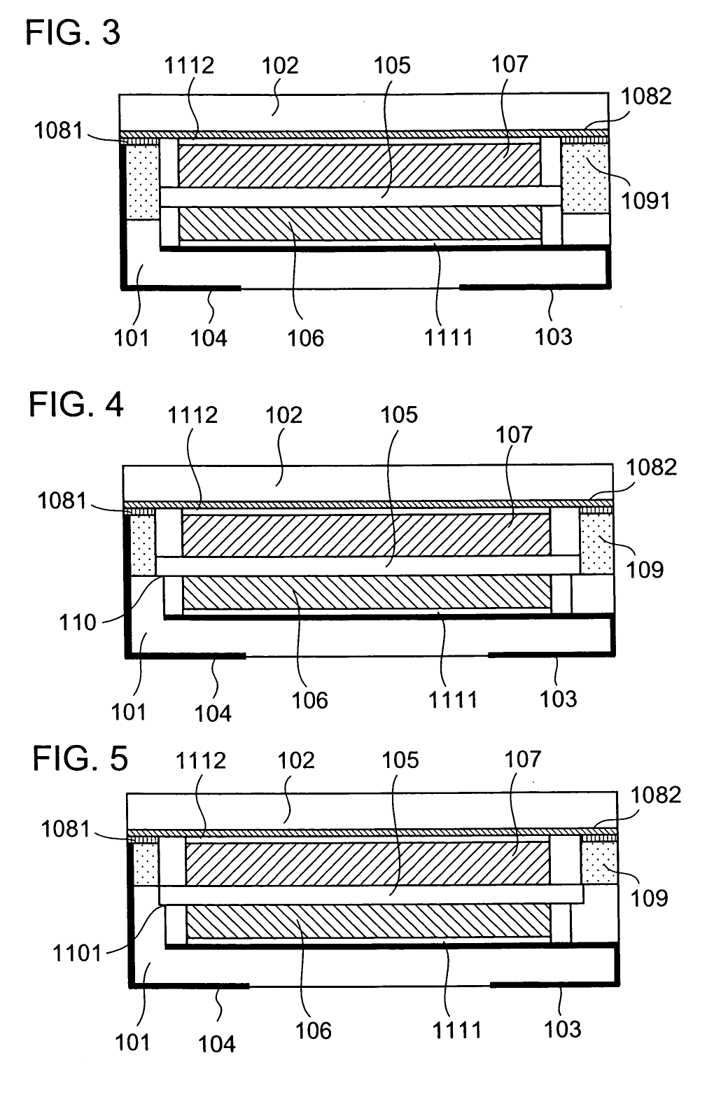

FIG. 1 is a cross sectional view of a non-aqueous electrolyte cell or electric double layer capacitor of the invention in the rectangular pyramidal form. A concave vessel 101 is made of alumina prepared by printing tungsten on a green sheet, placing a metal ring 109 made of Coval (alloy comprising Co: 17, Ni: 29, Fe: balance) thereon and sintering them. Further, a connection terminal A 103 and a connection terminal B 104 are applied with nickel/gold plating, and nickel and gold plating was applied as a brazing material 1081 (brazing material) on the metal ring 109. It was manufactured by the same method as a ceramic package for a usual quartz oscillator. Further, the thickness of the metal layer (metal ring 109 and brazing material 108) situated at the edge of the concave vessel 101 is made less than the total thickness for the negative electrode active substance 107 and the separator 105. In a case where the thickness of the metal layer is more than the total thickness for the negative electrode active substance 107 and the separator 105, the metal layer and the positive electrode active substance 106 may possibly be in contact with each other, failing to function as the non-aqueous electrolyte cell or electric double layer capacitor. FIG. 3 shows a cross sectional view in a case where the thickness of the metal layer is more than the total thickness for the negative electrode active substance 107 and the separator 105. When the position for the positive electrode active substance 106 is displaced by the scattering in the production step, it may possibly be in contact with the metal ring 109 to cause internal short-circuit.

The metal ring 109 is electrically connected by a tungsten layer passing through the lateral side on the left of the FIG. 1 to the connection terminal B 104.

While the connection terminals A, B reach the lower surface of the concave vessel and, even in a case where it remains on the lateral side of the vessel, it can be soldered with the substrate by the wetting with the solder.

A metal layer of tungsten used for wirings as the electrode collector is disposed for the entire surface at the bottom inside the concave vessel and it was penetrated through the wall of the concave vessel and connected electrically to the connection terminal A 103. The electrode collector and the positive electrode active substance 106 are bonded by a carbon-containing conductive adhesive 1111. There is no particular requirement of bonding the electrode collector and the positive electrode active substance 106 and it may be merely placed thereon. The positive electrode comprises the electrode collector and the positive electrode active substance 106.

Nickel plating to form a brazing material 1082 was applied to a portion of the sealing plate 102 on the side of the vessel. The sealing plate 102 and the negative electrode active substance 107 were previously bonded by a carbon-containing conductive adhesive 1112. The negative electrode comprises the sealing plate 102 and the negative electrode active substance 107. The pair of the positive electrode and the negative electrode form paired electrodes.

After containing the positive and negative electrodes, the separator 105 and the electrolyte inside the vessel and covering by the sealing plate 102, welding was conducted for the sealing plate 102 on every opposed two sides by a parallel seam welder utilizing the principle of resistance welding. Sealing at high reliability was obtained by the method described above.

The concave vessel 101 is preferably made of a heat resistant material such as a heat resistant resin, glass, ceramic or ceramic glass. As a manufacturing method, wirings may be applied by conductor printing to glass or glass ceramic at low melting point and laminated, and can be baked at low temperature. Alternatively, it may be laminated with an alumina green sheet by conductor printing and can be sintered.

It is preferred that the material for the metal ring 109 has a heat expansion coefficient approximate to that of the concave vessel 101.

For example, in a case of using alumina with a heat expansion coefficient of 6.8×10⁻⁶/° C. for the concave vessel 101, Coval with a heat expansion coefficient 5.2×10⁻⁶/° C. is used as the metal ring.

Further, it is preferred that Coval identical with that for the metal ring is used also for the sealing plate 102 in order to improve the reliability after welding. This is because the plate may be heated after welding when it is surface mounted to the substrate of an equipment, that is, during reflow soldering.

Further, a portion of the wirings to form the electrode collector is preferably made of tungsten, palladium, silver, platinum or gold that has a good corrosion-resistance and can be formed by a thick film method. Further, aluminum or carbon can also be used. In the case of using wirings at the bottom face of the concave vessel 101 as an electrode collector on the positive electrode side, gold or tungsten is particularly preferred. This is for avoiding melting of the material when a plus potential is applied by the use of a material of high withstanding voltage. Further, for improving the conduction between the electrode and the wirings, use of a carbon containing conductive adhesive is effective. Further, in a case of using a material of low withstanding voltage, it is effective to coat a carbon containing conductive adhesive solely to the metal of the electrode collector for the entire surface and then bake the same to harden to form the conductive layer. In a case of using aluminum, flame spraying or plating from a normal temperature molten salt (butyl pyridinium chloride plating bath, imidazolium chloride bath) can be utilized.

To the portion for the contact terminals A 103 and the contact terminal B 104, a layer of nickel, gold, tin or solder is preferably disposed for soldering with the substrate. Also for the edge of the concave vessel 101, it is preferred to dispose a layer of nickel or gold having good affinity with the bonding material. The layer forming method can include, for example, plating and gas phase method such as vapor deposition.

It is effective to provide a nickel and/or gold film as the brazing material to the surface bonded with the metal ring 109 and the sealing plate 102. While the melting point of gold is 1063° C. and the melting point of nickel is 1453° C., the melting point can be lowered to 1000° C. or lower by forming an alloy of gold and nickel. The method of forming the layer can include, for example, plating, a gas phase method such as vapor deposition or a thick film method using printing. A thick film method using plating or printing is particularly preferred in view of the cost.

It is, however, necessary to decrease impurity elements such as P, B, S, N, and C in the layer of the brazing material to 10% or less. Particularly, a care has to be taken in a case of using plating. For example, in electroless plating, they tend to intrude as P from sodium hypophosphite as a reducing agent and B from dimethylamine borane. Further, in electrolytic plating, since they may possibly be intruded from additives such as a brighteners or anions, a care has to be taken. It is necessary to restrict the intruding impurities to 10% or less by adjusting the amount of the reducing agent, the additives and the like. If they are incorporated by 10% or more, intermetallic compounds are formed to the bonded surface to cause cracks.

In a case of using nickel for the brazing material 1082 on the side of the sealing plate 102, gold is used preferably for the brazing material 1082 on the side of the concave vessel 101. The gold to nickel ratio is preferably between 1:2 and 1:1 and the welding temperature is lowered by lowering of the melting point of the alloy to improve the bondability as well.

For the welding of the bonded portion, seam welding utilizing the resistance welding method can be used. After provisionally securing the sealing plate 102 and the concave vessel 101 by spot welding, a roller type electrode is pressed against the opposed two sides of the sealing plate 102 and current is supplied to conduct welding according to the principle of the resistance welding. Sealing can be attained by welding the four sides of the sealing plate 102. Since current is supplied pulsatively while rotating the roller electrode, seam-like state is obtained after welding. Complete sealing can not be attained unless the pulse width is controlled such that individual welding traces by pulses overlap to each other.

In the welding for the cell or the capacitor containing the electrolyte (liquid), seam welding utilizing the resistance welding method is particularly preferred. In a case of welding such as by laser, welding was difficult due to the effect of the electrolyte as a liquid unless a further large welding margin is available.

The separator used is preferably a heat resistant no-woven fabric. For example, in a separator such as made of a rolled porous film, it is heat resistant but it shrinks in the rolling direction by the heat upon seam welding utilizing the resistance welding method. As a result, it tends to cause internal short-circuit. Separators using heat resistant resins or glass fibers were satisfactory with less shrinkage. As the resin, PPS (polyphenylene sulfide) and PEEK (polyetheretherketone) were favorable. Glass fibers were particularly effective. Further, a porous ceramic body can also be used.

For preventing the internal short-circuit, it is effective to provide a step inside the concave vessel 101 and dispose a separator on the step. As shown in FIG. 4, the thickness of the metal ring 109 is reduced to less than the wall on the lateral side of the concave vessel 101 to form a step 110 and the separator was disposed on the step. This could greatly decrease the internal short-circuit. Further, it was also effective to provide a step 1101 in the wall on the lateral side of the concave vessel 101 as shown in FIG. 5.

The shape of the non-aqueous electrolyte cell or electric double layer capacitor in the invention is basically optional. The shape of the existent electric double layer capacitor obtained by damping and sealing shown in FIG. 2 is restricted substantially to a circular shape. Accordingly, in a case where it is intended to arrange on a substrate identical with other electronic parts most of which are in a rectangular shape, a dead space was inevitably formed wastefully. Since the electric double layer capacitor of the invention can be designed also as a rectangular shape and has no protrusions such as terminals, it can be disposed efficiently on a substrate.

According to the non-aqueous electrolyte cell or electric double layer capacitor of the invention, since the connection terminals are integrated with the containing vessel and disposed to a lower portion of the vessel, space on the substrate can be saved. Further, they can cope with reflow soldering by constituting them by heat resistant material.

What is claimed is:

1. An electrochemical cell comprising paired electrodes having a positive electrode and a negative electrode, a separator for separating the positive electrode and the negative electrode, an electrolyte, a concave vessel for containing the paired electrodes, the separator and the electrolyte, and a sealing plate for sealing the concave vessel in which a metal layer is disposed the edge of the concave vessel, and the concave vessel and the sealing plate are bonded by resistance welding.

2. An electrochemical cell according to claim 1, wherein the metal layer comprises, a metal ring and a brazing material having a heat expansion coefficient approximate with that of the concave vessel, and the concave vessel and the sealing plate are bonded by seam welding.

3. An electrochemical cell according to claim 1, wherein the concave vessel comprises ceramics or ceramic glass.

4. An electrochemical cell according to claim 2, wherein the metal ring comprises an alloy containing cobalt, nickel and iron, and the brazing material is a nickel and/or gold film formed on the metal ring.

5. An electrochemical cell according to claim 2, wherein the sealing plate comprises a metal in which a brazing material is formed to the surface on the side bonded with the concave vessel.

6. An electrochemical cell according to claim 5, wherein the metal of the sealing plate comprises an alloy containing cobalt, nickel and iron, and a brazing material formed at the surface on the side bonded with the concave vessel is a nickel and/or gold film.

7. An electrochemical cell according to claim 2, wherein the brazing material is formed by plating or printing.

8. An electrochemical cell according to claim 1, wherein the thickness for the metal layer situated to the edge of the concave vessel is less than the total thickness for the electrode situated on the side of the sealing plate and the separator.

9. An electrochemical cell according to claim 1, wherein a step is provided inside the concave vessel and a separator is disposed on the step.

10. An electrochemical cell according to claim 1, wherein an electrode collector is disposed at the bottom surface inside the concave vessel.

11. An electrochemical cell according to claim 10, wherein the electrode collector comprises a material mainly comprising elements selected from tungsten, aluminum, carbon, palladium, silver, platinum and gold.

12. An electrochemical cell according to claim 10, wherein a layer having a conductivity mainly comprising carbon is further provided on the electrode collector at the bottom surface inside the concave vessel.

13. An electrochemical cell according to claim 1, wherein the separator comprises a non-woven fabric.

14. An electrochemical cell according to claim 1, wherein the main ingredient of the separator comprises polyphenylene sulfide, polyetheretherketone or glass fibers.
